(19) United States
(12) Patent Application Publication
(10) Pub. No.: US 2005/0257781 A1
(43) Pub. Date: Nov. 24, 2005

(54) Intake air pre-heated assembly for automotive gasoline engines

(76) Inventor: Thomas Ellen Linkenhoger, Tampa, FL (US)

Correspondence Address: THOMAS E. LINKENHOGER, 13516 WEST HILLSBOROUGH AVENUE, LOT 49A, TAMPA, FL, 33635, US

(21) Appl. No.: 10/848,910

(22) Filed: May 19, 2004

(51) Int. Cl. F02M 53/00; F02G 5/00

(52) U.S. Cl. 123/549; 123/543; 123/556

(57) ABSTRACT

The basis for the Intake Air Pre-Heater Assembly For Automotive Gasoline Engines is my understanding and experience with automotive gasoline engines. It has been mentioned in the automotive industry that only half of the energy in a gallon of gasoline is used to move the vehicle down the road. Another 25% is transformed and lost to heat and the rest is blown out the tail pipe as unburned fuel even if the engine is at a running temperature of 180 degrees. It is common knowledge that heat speeds up the vaporizing of gasoline and that a lot of fuel is lost during the first 10 minutes the engine is running (cold start). I am sure this is true for any automotive gasoline engine including the multiple fuel injector engines that are the majority of of the automotive engines in the world today. I believe this invention will help reduce this waste of energy and it can easily be installed by the average do it your self person and commercial auto garage mechanic.

### BACKGROUND OF THE INVENTION

It is known by the automotive industry that gasoline engines do not burn all of the gasoline fuel going through the engine. The probable cause of this is the rapidity by which the fuel moves through the engine which does not allow all of the gasoline to vaporize while going into the combustion cylinders. It is also known that gasoline will burn only when it is in a “gas” or evaporated state. Therefore the amount of evaporated fuel going into the combustion cylinders is crucial to the performance of the engine and fuel economy.

It is my understanding that fuel injectors do not vaporize the gasoline they only spray it which means the fuel still has to vaporize while going into the combustion cylinders and this would include automotive gasoline multiple fuel injector engines which are the majority of the automotive engines in the world today.

### BRIEF SUMMARY OF THE INVENTION

The Intake Air Pre-Heater Assembly will be of low cost to the general public and is easily installed by the average do it yourself person and commercial auto garage mechanic.

The purpose of Intake Air Pre-Heater Assembly is to vaporize more of the gasoline going into the combustion cylinders of the common automotive gasoline multiple fuel injector engine.

The benefits would be:
# 1 Improved fuel economy
# 2 An increase in engine power
# 3 Reduced air emissions
# 4 Less carbon and varnish deposits on engine components
# 5 Increased longevity of the life of the engine
# 6 Better control of the vehicle

### DESCRIPTION OF THE RELATED ART

The Intake Air Pre-Heater Assembly for Automotive Gasoline Engines applies in particular to to Multiple Fuel Injector Gasoline Engines because they do not have any kind of Intake Air Pre-Heater installed on them. It is a known fact that intake air pre-heaters preform a very useful purpose because mechanical intake air pre-heaters have been installed on millions of other vehicle gasoline engines and are known as “Early Fuel Evaporation” systems. This system channels warm air from one of the exhaust manifolds into the air intake duct of the air filter until the engine warms up and then the warm air is shut off by a thermal vacuum valve or a thermal coiled spring.

Since heat speeds up the vaporizing of gasoline I have invented a Electrical Intake Air Pre-Heater Assembly that consist of a perforated sheet metal enclosure and a common heater filament designed as a small compact unit that can be placed inside the air intake duct of the air filter of the average automotive fuel injector gasoline engine and may also be installed on engines with existing mechanical “Fuel Evaporation” systems and will work in combination with the mechanical system to improve engine performance and fuel economy.

The new electrical intake air pre-heat assembly appears to be more efficient then the mechanical “Early Fuel Evaporation” system because it immediately begins heating the intake air as soon as the engine starts running.

There is no indication of any harm to the engine but rather the two systems working together achieves a faster engine warm up time.

### DESCRIPTION OF THE DRAWINGS

These drawings will identify the individual components (parts) and their function that make up the invention. Also a electrical schematic and a mechanical illustration of the physical placement of the individual components as installed on a gasoline engine are presented.

Drawing # 1: Is a mechanical illustration of the physical placement and the wiring connections of the individual components on a six cylinder engine.

Drawing # 2: Is a condensed electrical schematic of the wiring and components as they would be connected on a gasoline engine.

Drawing # 3: (FIG. A) Is a illustration and size specifications of the aluminum enclosure the heater filament is secured inside of. FIG. B shows the size specifications of the heater filament and removed from the inside of the perforated aluminum enclosure.

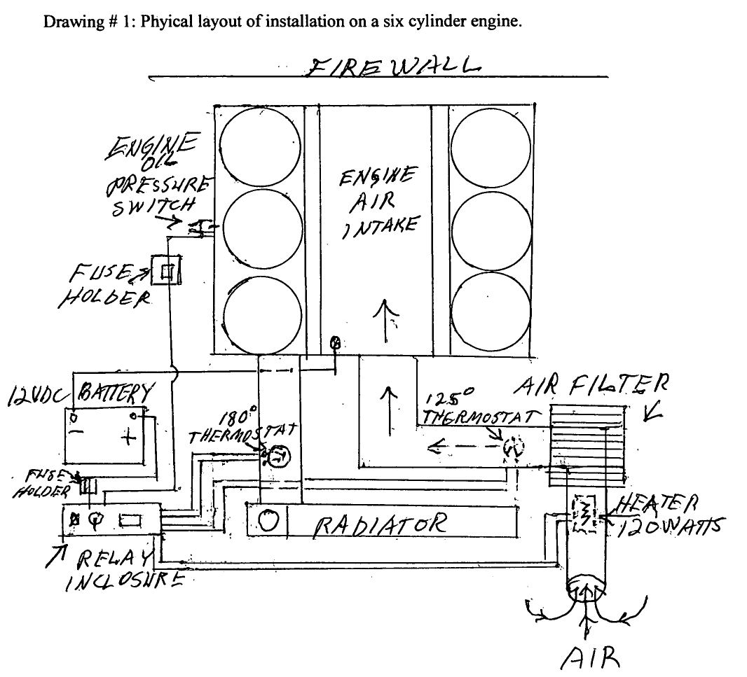

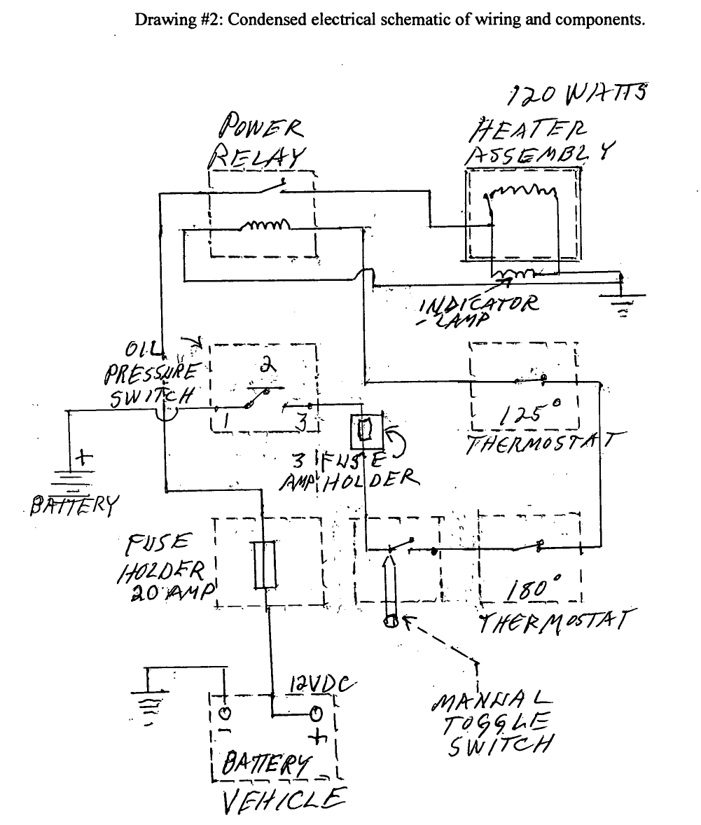

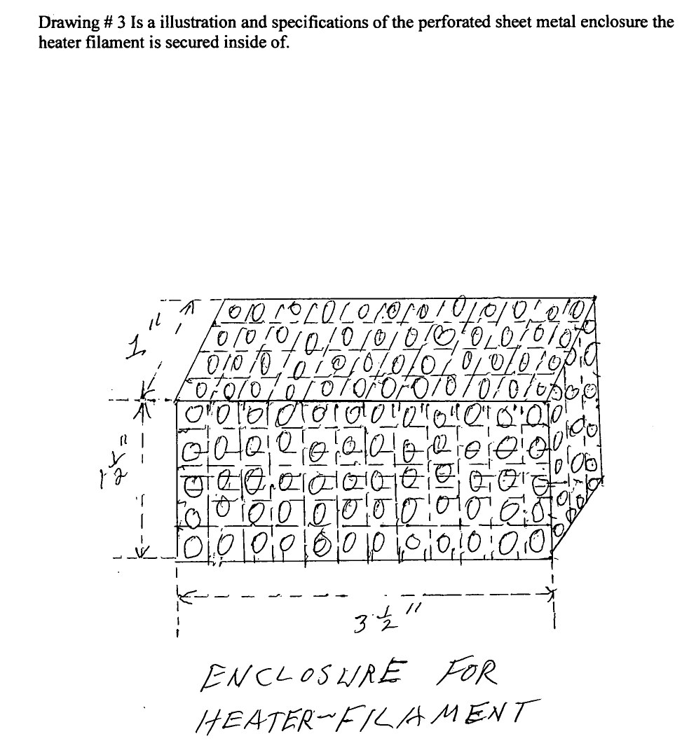

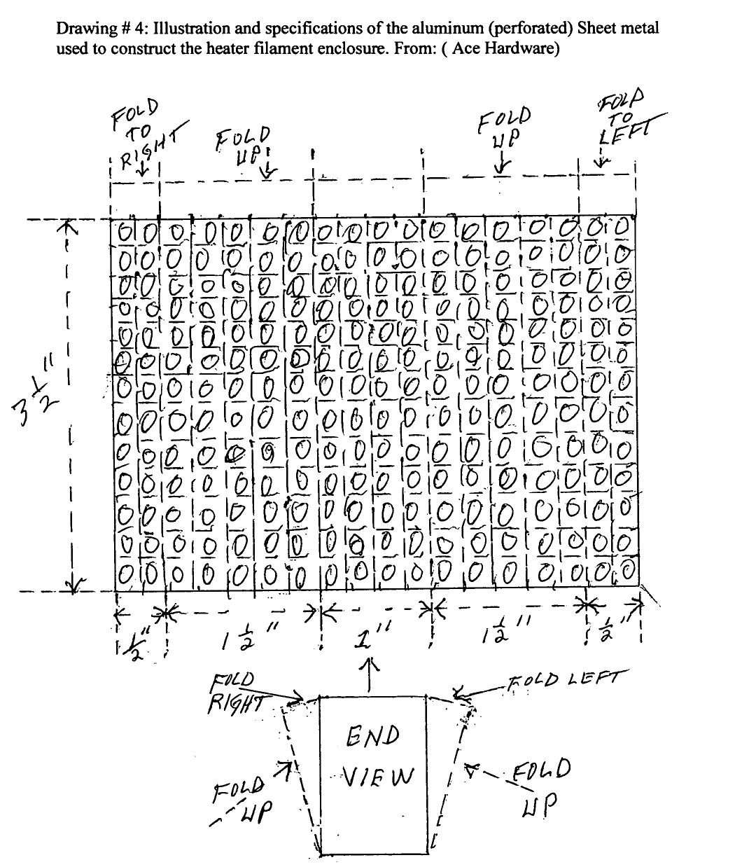

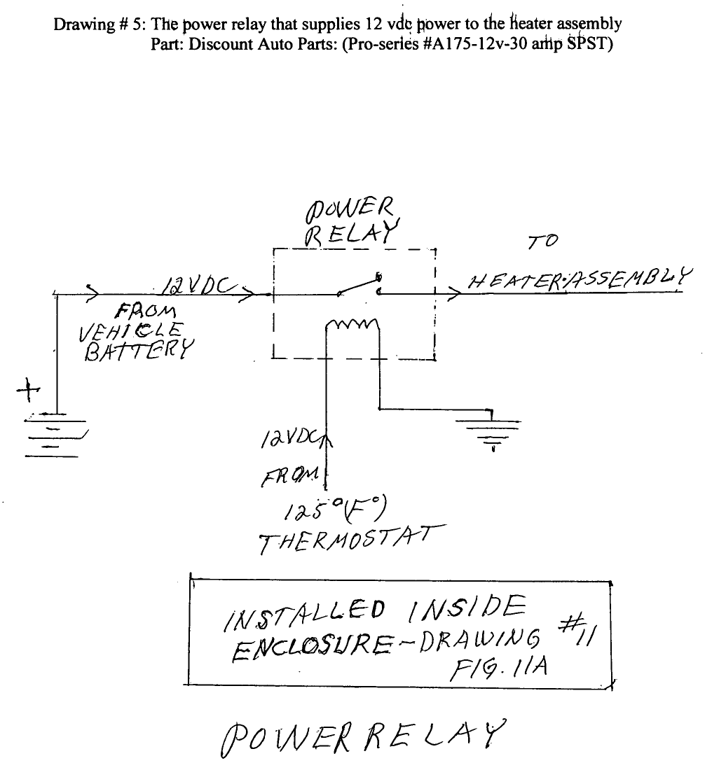

Drawing # 4: (FIG. 4 A) Is a illustration and size specifications of the perforated aluminum sheet metal used to construct the enclosure for the heater filament. FIG. 4 B Shows the folding method used to form the rectangular shape of the enclosure.

Drawing # 5: The relay that supplies 12 vdc power to the Intake Air Pre-Heater Assembly.

Drawing # 6: A heat sensing thermostat switch (190 F′) that disconnects the Intake Air Pre-Heater Assembly if the engine begins to over heat for any reason.

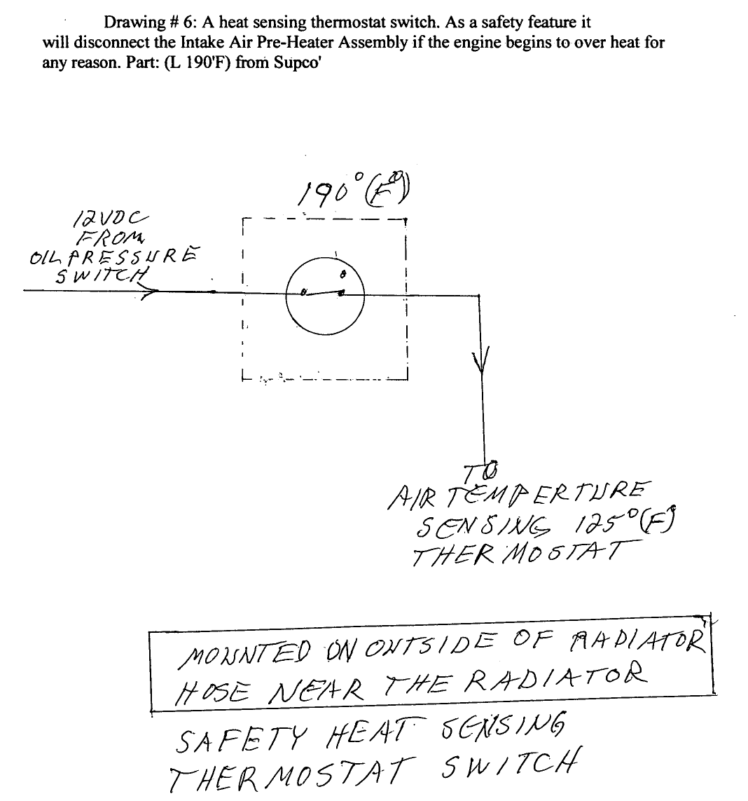

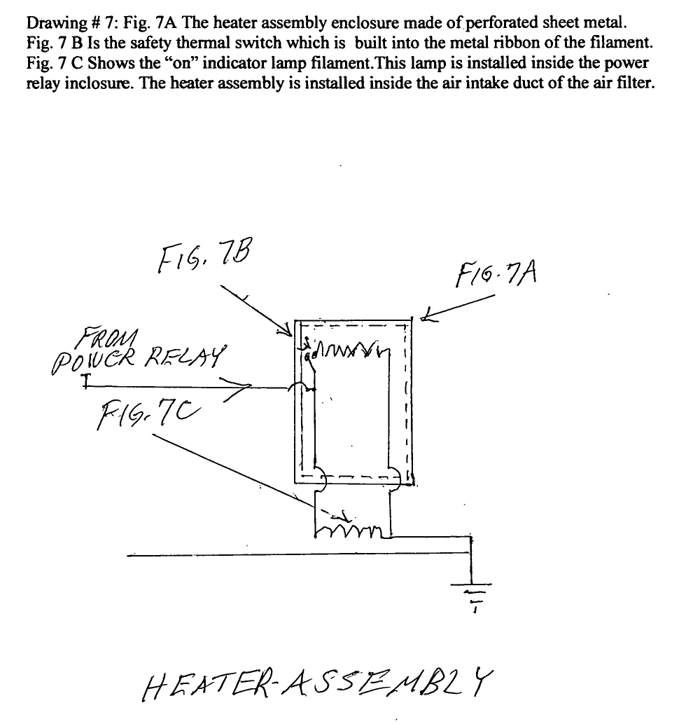

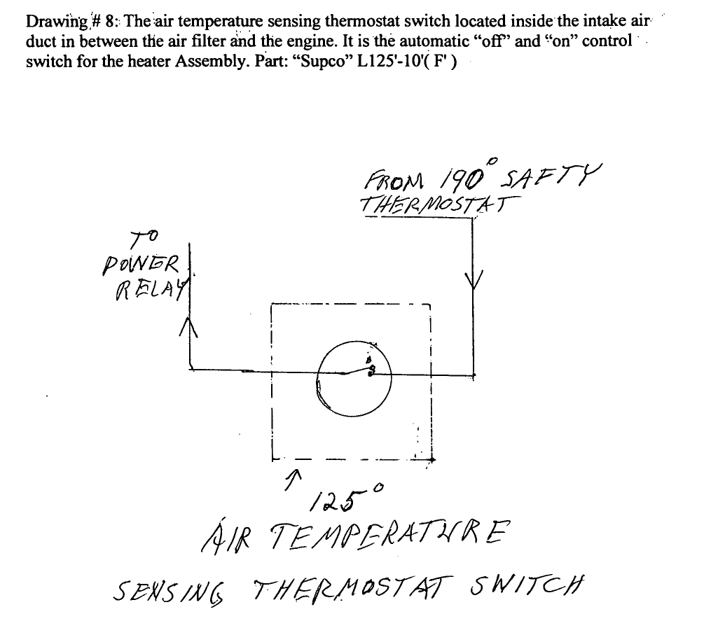

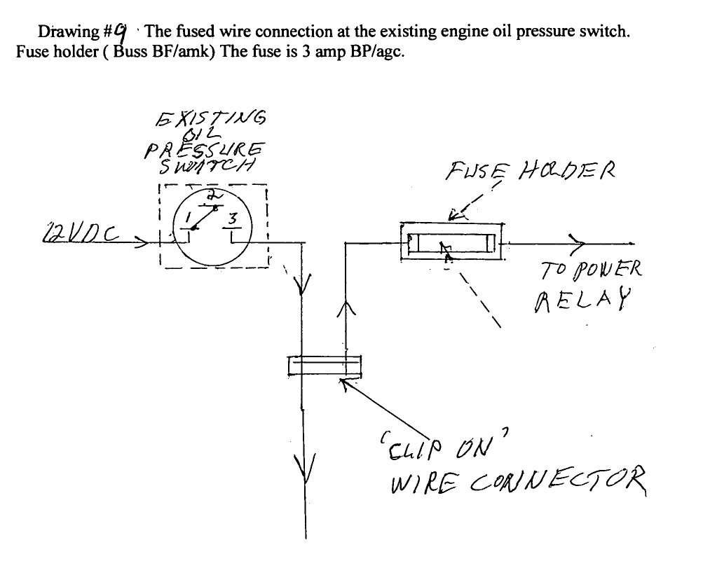

Drawing # 7: (FIG. 7 A) Is a diagram of the heater filament indicating the thermal safety switch built into the metal ribbon of the filament. (FIG. 7 B) Is the perforated sheet metal enclosure. (FIG. 7 C) Is the “on” indicator lamp installed on the top cover of the power relay enclosure.

Drawing # 8: The thermostat switch (125 F′) that turns the heater assembly “on” and “off”.

### DESCRIPTION OF THE DRAWINGS

Drawing # 9: Is the fused wire connection at the existing engine oil pressure switch that energizes the heater assembly power relay. When the engine starts running and oil pressure is applied to the switch the Intake Air Pre-Heater Assembly is turned “on”.

Drawing # 10: Indicates the fused wire connection at the vehicle battery and the fuse holder and fuse (20 Amp).

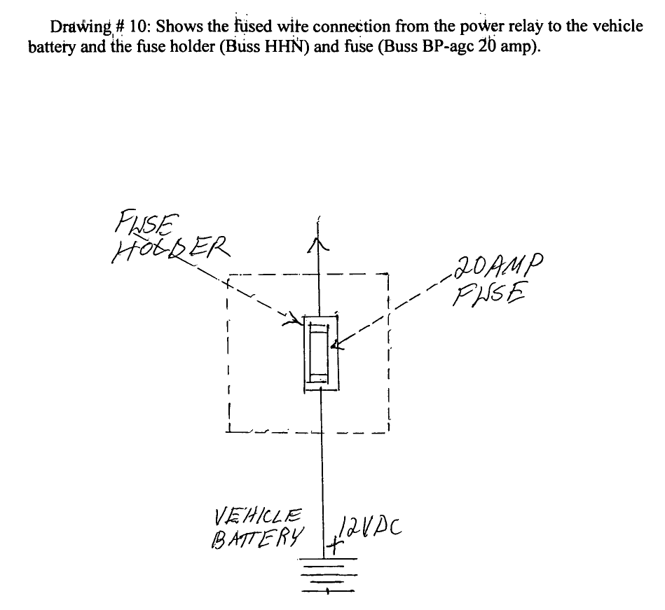

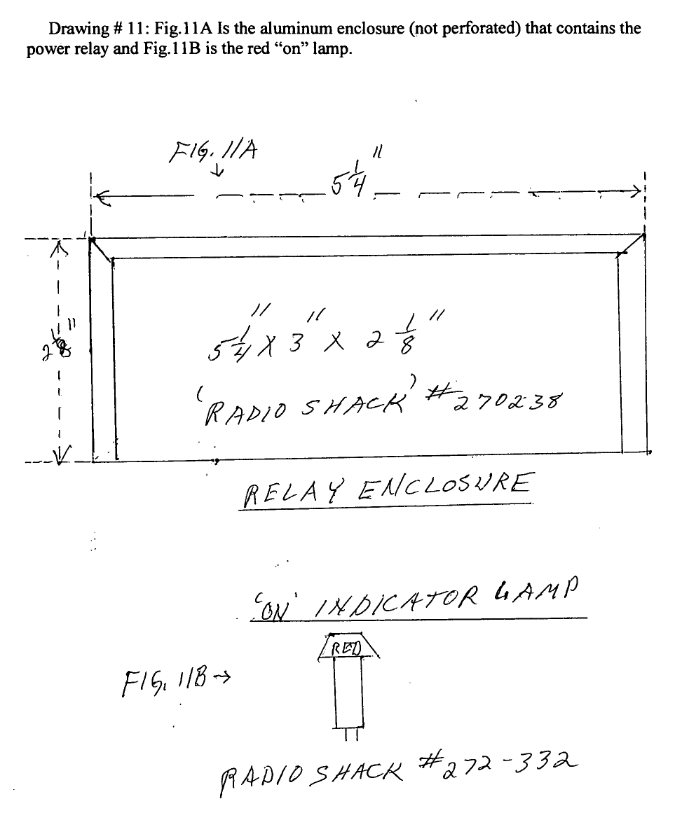

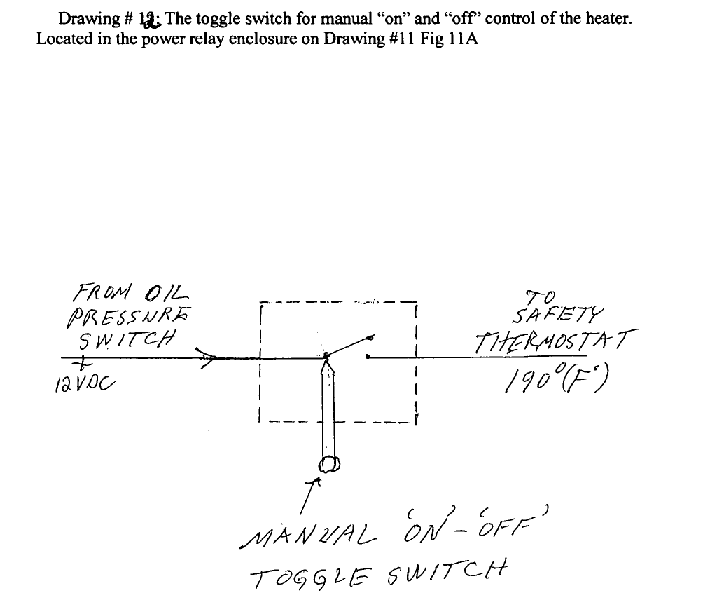

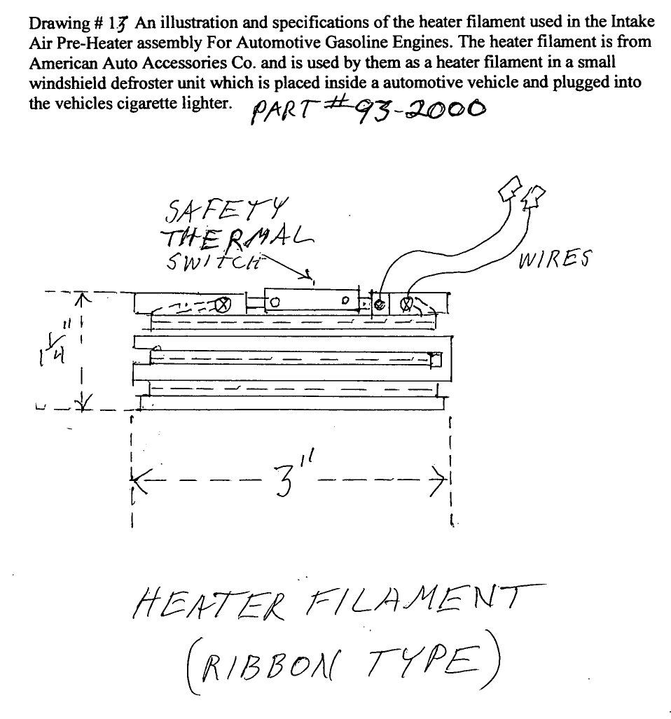

Drawing # 11: (FIG. 11A) Is the aluminum enclosure (not perforated) that contains the power relay, the heater assembly manual “on” and “off” toggle switch and the “on” indicator lamp.

Drawing # 12: Is the “Manual” toggle switch that will allow the Heater Assembly to operate in automatic mode when switched to “on”. When the toggle switch is “off” the Heater Assembly and its supporting components are disconnected from the engine oil pressure switch.

Drawing # 13: Is the common heater filament used in combination with the new design of filament enclosure. This heater filament is from American Auto Accessories Co. and is used by them as a heater filament in a windshield defroster unit that is placed inside a vehicle and plugged into the vehicles cigarette lighter socket.

### DETAILED DESCRIPTION OF THE INVENTION

The Intake Air Pre-Heater Assembly consist of perforated aluminum sheet metal enclosure shaped to enclose a common heater filament. The two together make up a Heater Assembly of which can easily be placed inside the intake air duct of the average automotive gasoline engine. Drawing # 3 (Page 11) is a illustration of the perforated sheet metal enclosure. Drawing # 13 (Page 21) is a illustration of the heater filament.

The Intake Air Pre-Heater Assembly is electrical (12 vdc) and is powered by the vehicle electrical system. The heater filament is 120 watts at 10 amperes continuous with the heater assembly “on”.

The installation of the Intake Air Pre-Heater Assembly involves the strategic placement of the heater assembly inside the air intake duct of the air filter and a control thermostat switch placed inside the intake air duct in between the air filter and the engine. This thermostat is placed close to the air filter and is the control component that turns the heater assembly “on” and “off” according to the temperature of the air flowing through the intake air duct over the thermostat and into the throttle body of the engine.

The 12 vdc to turn the heater assembly “on” is by a fused wire connection at the output of the existing engine oil pressure switch. When the engine starts running the oil pressure switch energies a power relay which turns the heater assembly “on”. The 12 vdc power for the heater assembly is from a fused wire connection between the power relay and the vehicles battery.

The improvement in fuel economy and engine power appears to be significant during short trips of approximately 10 minuets more or less which is typical of many drivers and which is the required warm up time for the average automotive gasoline engine.

1. What I claim as my invention is a heater assembly consisting of a perforated metal enclosure in combination with a common heater filament of such small size so that the heater assembly can easily be placed inside the intake air duct of the average automotive gasoline engine.

2. The strategic placement of the Intake Air Pre-Heater Assembly (presented in claim 1) and its supporting components is designed to accommodate the common multiple fuel injector gasoline engines that do not have any kind of of intake air pre-heater installed on them.

3. The Intake Air Pre-Heater Assembly (presented in claim 1) is electrical and therefore is suitable for installation on automotive gasoline engine's that have factory installed mechanical. “Fuel Evaporation” systems. The electrical Intake Air Pre-Heat Assembly will work in combination with the mechanical system for a faster engine warm up time-fuel economy- and more engine power.
